(19) United States
(12) Patent Application Publication
(10) Pub. No.: US 2010/0071512 A1
(43) Pub. Date: Mar. 25, 2010

(54) SYSTEM, METHOD AND APPARATUS FOR ENHANCED CUTTING ELEMENT RETENTION AND SUPPORT IN A ROCK BIT

(75) Inventors: Tu Tien Trinh, Houston, TX (US); Eric Sullivan, Houston, TX (US)

Correspondence Address: TRASKBRITT, P.C., P.O. BOX 2550, SALT LAKE CITY, UT, 84110, US

(73) Assignee: BAKER HUGHES INCORPORATED, Houston, TX (US)

(21) Appl. No.: 12/237,421

(22) Filed: Sep. 25, 2008

(51) Int. Cl. B23P 15/32; B21K 5/04

(52) U.S. Cl. 76/108.2; 148/559

(57) ABSTRACT

A rock bit is formed with pockets for enhanced cutting element retention and support of the cutting elements during operation of the rock bit. Portions of the pockets are carburized to increase the yield strength of the pockets which also increases the retention of the cutting elements. The pockets are formed at a diameter that is slightly smaller than the outer diameter of the cutting elements. Portions of the pockets are then carburized. The pockets are heated until the diameter of the pockets is equal to the diameter of the cutting elements. After the cones have been cooled and cleaned, a material is placed in each pocket prior to installing the cutting elements. The material homogenizes support for the cutting elements during operation of the rock bit.

### BACKGROUND OF THE INVENTION

1. Technical Field

The present invention relates in general to cutting elements for rock bits and, in particular, to an improved system, method and apparatus for enhanced cutting element retention and support in a rock bit.

2. Description of the Related Art

Rock cutting structures are commercially manufactured using a supporting structure which may be cast, forged and machined. The supporting structure supports rock cutting elements which may be formed either as an integral part of the supporting structure, or as a separate element that is joined to the supporting structure by being forced into an undersized retaining bore formed by and within the supporting structure to effect a tight interference fit therewith.

Various sequencing and scheduling strategies are resorted to in manufacturing in order to avoid heat treatments after the cutting elements are pressed into place. This avoids thermal relaxation of the induced stresses provided by the pressing operation. Such a reduction of induced stresses would result in an unacceptable reduction in the retention or holding force provided by the interference fitting operation.

The steels commonly used to produce rock bit cutting structures are graded which carburize or nitride readily, thus providing a relatively soft core with a hard wear resistant skin. To form this hard skin on the inner surface of the retention bores would seriously interfere with the installation of the teeth therein, and so generally the supporting structure is first carburized, then the carburized surface is machined away in the locations intended for retention bores, then hardened with heat treatment before the retention bores are machined.

A conventional three-cone rotary rock bit has, typically, from about 100 to about 300 inserted teeth, each of which is carefully fit to provide about 0.004 inch interference fit. Tests indicate that about 0.001 inch interference fit remains as stored stress within the assembly after the pressing, the rest being lost to shearing, galling, and yielding of the steel of the supporting structure. The roller cones and teeth are washed before insertion of the teeth, and no lube is used to install them—they are press fit only. Thus, no fluid is intentionally left behind in the pockets when the teeth are installed.

The irregular heavy impact loads imposed upon the rock bit assembly during drilling tend to cause further yielding in the supporting structure with the subsequent enlargement of retaining bores, and, occasionally, the resultant loss of hard-metal rock cutting teeth within the well bore. Such a lost tooth is no longer operational as a cutting device against the rock, but does constitute a source of considerable damage or fracture to the remaining teeth in the rock bit. Serious damage can also occur as a result of a dislodged tooth becoming jammed between cones, or between a cone and the body of the rock bit, thereby interfering with the rotation and cutting action of the cones involved, and of the bit. When cone rotation ceases, a skidding action occurs between the well bore bottom and the cone or cones, a stopped cone quickly causes self-destruction of the cutting apparatus. Thus, an improved system, method and apparatus for enhanced cutting element retention and support in a rock bit would be desirable.

### SUMMARY OF THE INVENTION

Embodiments of a system, method, and apparatus for enhanced cutting element retention and support in a rock bit are disclosed. The rock bit has pockets formed in it for the installation of cutting elements (e.g., compacts). Portions of the pockets are carburized to increase the yield strength of the pockets which also increases the retention of the compacts. A material such as an incompressible fluid is placed in each pocket and acts to homogenize support for the cutting elements during operation of the rock bit. This feature also has the advantage of inhibiting or reducing the formation of cracks in the rock bit.

In one embodiment, the pockets are milled into the roller cones of a rock bit. The pockets are milled prior to heat treatment of the roller cones. The pockets are formed at a diameter that is slightly smaller than the outer diameter of the compacts. Portions of the pockets are then carburized. The roller cones are heated until the diameter of the pockets is equal to the diameter of the compacts. After the cones have cooled and been cleaned, a small amount of oil is inserted at the bottoms of the pockets and the compacts are then pressed into their places. Subsequent heat treatment is used to exploit the carburization.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention are attained and can be understood in more detail, a more particular description of the invention briefly summarized above may be had by reference to the embodiments thereof that are illustrated in the appended drawings. However, the drawings illustrate only some embodiments of the invention and therefore are not to be considered limiting of its scope as the invention may admit to other equally effective embodiments.

FIG. 1 is an isometric view of one embodiment of a roller cone rock bit constructed in accordance with the invention;

FIG. 2 is a sectional view of one embodiment of a leg of a roller cone rock bit constructed in accordance with the invention;

FIG. 3 is an isometric view of another embodiment of an earth boring bit constructed in accordance with the invention; and

FIG. 4 is a schematic sectional side view of one embodiment of a roller cone and cutting element constructed in accordance with the invention.

### DETAILED DESCRIPTION OF THE INVENTION

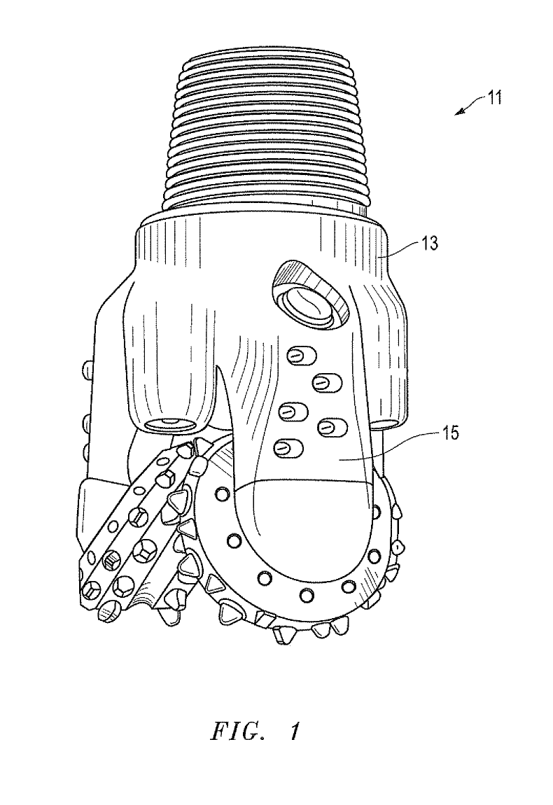

Referring to FIGS. 1-4, embodiments of a system, method and apparatus for enhanced cutting element retention and support in a rock bit are disclosed. The invention is well suited for many types of rock bits including roller cone drill bits and fixed blade drill bits.

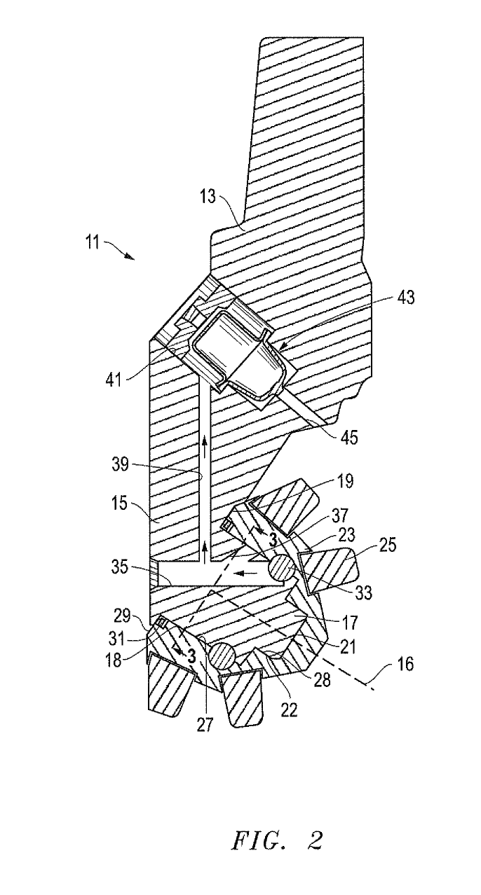

For example, FIGS. 1 and 2 illustrate one embodiment of a rock bit 11 having a body 13 with a threaded upper end for attachment to the lower end of a drill string. Body 13 has at least one bit leg 15 (e.g., typically three) that extend downward from it. Each bit leg 15 has a bearing pin 17 (FIG. 2) that extends downward and inward along an axis 16. Bearing pin 17 has an outer end, referred to as the last machined surface 19, where it joins bit leg 15.

In the embodiment shown, bearing pin 17 has a main journal surface 18 and a nose 21 having a smaller diameter than surface 18 that is formed on its inner end. Nose 21 also has a pilot pin radial bearing surface 22 that is parallel to surface 18 relative to axis 16. In another embodiment (e.g., for larger diameter bits), roller bearings may be used instead of journal bearings. The invention is well suited for both types of applications.

A roller cone 23 is rotatably mounted to bearing pin 17. Cone 23 has a plurality of cutting elements 25 mounted thereto and protruding therefrom. Cone 23 has a cavity 27 that is slightly larger than the outer diameters of bearing pin 17. Cone 23 may be retained in more than one manner In the embodiment shown, cone 23 is retained on bearing pin 17 by a plurality of balls 33 that engage a mating annular recess formed in cone cavity 27 and on bearing pin 17. Balls 33 lock the roller cone 23 to bearing pin 17 and are inserted through a ball passage 35 during assembly after cone 23 is placed on bearing pin 17. Ball passage 35 extends to the exterior of bit leg 15 and may be plugged as shown after balls 33 are installed.

In the illustrated embodiment, a portion of cavity 27 slidingly engages journal surfaces 18 and 22. The outer end of journal surface 18 is at a junction with the gland area engaged by a seal 31, and the inner end of journal surface 18 is considered to be at the junction with the groove or race for balls 33. Journal surfaces 18 and 22 serve as a journal bearing for loads imposed along the axis of bit 11. Again, other types of drill bits may utilize roller bearings instead of journal bearing surfaces and are readily configured for the invention.

In a sealed lubricated bearings embodiment, a lubricant port 37 is located on an exterior portion of journal surface 18 of bearing pin 17. The port 37 is connected to a passage 39 via ball passage 35. Passage 39 leads to a lubricant reservoir 41 that contains a lubricant. Lubricant reservoir 41 may be of a variety of types. In one embodiment, an elastomeric diaphragm 43 separates lubricant in lubricant reservoir 41 from a communication port 45 that leads to the exterior of bit body 13. Communication port 45 communicates the hydrostatic pressure on the exterior of bit 11 with pressure compensator 43 to reduce and preferably equalize the pressure differential between the lubricant and the hydrostatic pressure on the exterior. Cone 23 also has a back face 29 that is located adjacent, but not touching, last machined surface 19.

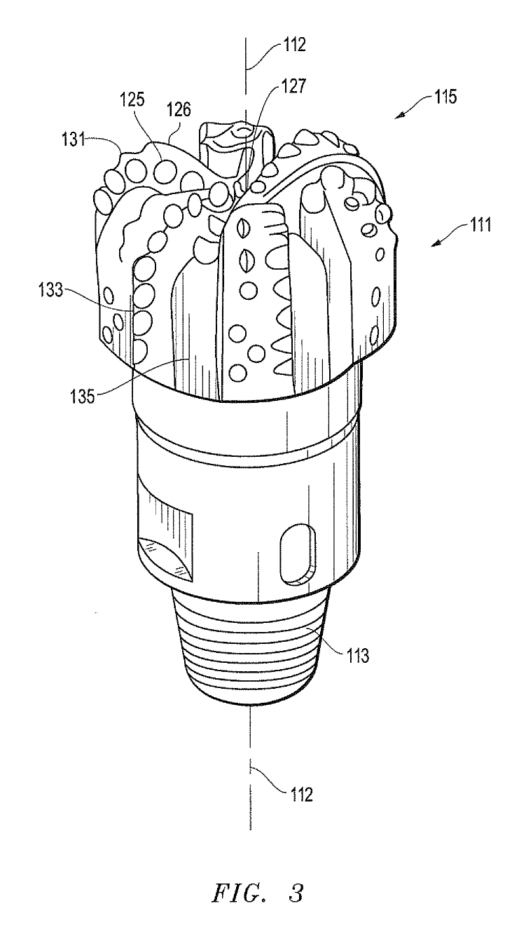

FIG. 3 depicts one embodiment of a fixed cutter rotary drill bit 111 is shown. Bit 111 has a rotational axis 112 and a threaded end 113 for connection into a drill string. A cutting end 115 with a series of blades (e.g., six shown) at a generally opposite end of the bit 111 is provided with a plurality of hard cutting elements 125 (e.g., polycrystalline diamond cutters, etc.) arranged about cutting end 115 to effect efficient removal or cutting of formation material as bit 111 is rotated in a borehole.

The cutting elements 125 are secured in a pocket provided on cutting end 115 such that they engage formation material. Cutting elements 125 may comprise many different shapes, such as a frustoconical cutting element having a beveled edge. Cutting elements 125 may act somewhat like a plow that generally directs a high percentage of the material of the formation up the flat face.

The arrangement of cutting elements 125 on each blade of bit 111 is configured in an overall cutting profile about bit axis 112. Starting at axis 112 and moving toward the outer diameter of bit 111, the profile includes a cone 127, a nose 126, a shoulder 131, and a gage pad or surface 133. The gage surface 133 essentially defines the flat, outer diameter portion of bit 111 that extends from cutting end 115 and is proximal to and contacts the sidewall of the borehole during drilling operation of bit 111. A plurality of channels or junk slots 135 extend from cutting end 115 through gage surface 133 to provide a clearance area for the removal of cuttings and chips formed by cutting elements 125.

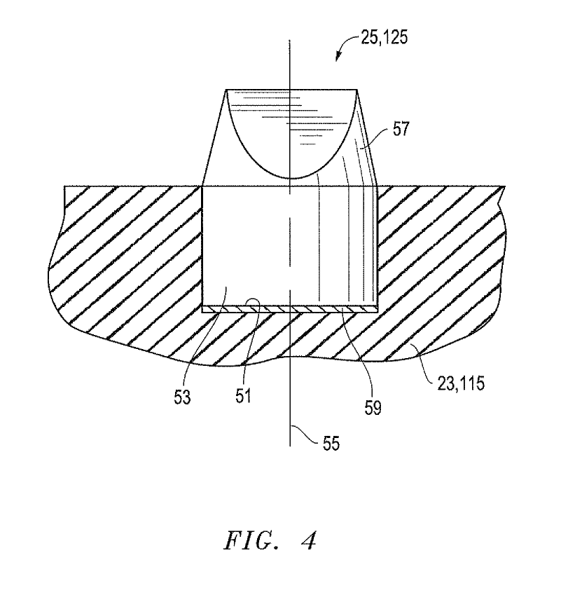

Referring now to the enlarged view of FIG. 4, each cutting element 25, 125 is mounted in a pocket 51 formed in either the cones or blades of the bits. The cutting element may be provided with a cylindrical base 53 with an axis 55 and a cutter 57 affixed thereto. The cutting elements also may be provided with a substrate extension that may be formed from the same material as the base. The substrate extension is secured to the base opposite the cutter.

A fluid 59, such as an incompressible fluid comprising a lubricant, oil, or grease is placed between a bottom of the pocket 51 and the base of the cutting element. The fluid acts as a homogenizing support for the cutting element during operation of the rock bit. The fluid also reduces the formation of cracks in the rock bit during operation of the rock bit. The presence of fluid in the pocket forms a hydrostatic load that evenly distributes forces between the bottoms of the pocket and cutting element. Alternatively, a disk, such as a flat plastic disk or deformable metallic disk, may be used in lieu of fluid for the same purposes.

The invention also comprises a method of forming a rock bit. In one embodiment, the method begins as indicated and comprises providing a rock bit with cutting elements, such as cylindrical bodied cutting elements. Pockets are formed (e.g., cylindrical pockets) in the rock bit for the cutting elements, such that the pockets have a first diameter that is smaller (e.g., about 0.060″) than the cutting elements (e.g., a diameter of the cylindrical portion of the cutting elements). The pockets may be milled in the rock bit.

The pockets may be carburized and heated such that the pockets expand to a second diameter that is approximately equal to the diameter of the cutting elements. Carburization is a diffusion process to augment a material with carbon. Only the surfaces of the workpieces are carburized to locally change their metallurgical properties. This process may comprise carburization, air cooling, heating the cone or bit, austentizing, oil quenching (hardening), and tempering. This processing increases a yield strength of the pockets and increases retention of the cutting elements in the pockets.

Subsequent to carburizing, heat treatment is used in some embodiments to exploit the carburization. For example, the components may be austenitized, oil quenched and tempered to realize the improvement in yield strength. The pockets may be plastically formed rather than machined if (a) the as-carburized gradient was satisfactory and no stock had to be removed, and (b) if the pockets were shrunk about an undersized displacement. In one embodiment, the invention may comprise: (1) form undersized pockets, (2) carburize selected portions of the pocket interior, (3) remove the machining stock, (4) austenitize, oil quench and temper, (5) finish machine the part (including the pockets) and (6) either shrink fit (e.g., under tempering temperature constraints) or press fit the compacts or cutting elements.

Thereafter, a fluid is placed in the bottoms of the pockets before the cutting elements are installed in (e.g., pressed into) the pockets. As described herein, the fluid may comprise an incompressible fluid selected from the group consisting of a lubricant, oil, and grease, and the fluid acts as a homogenizing support for the cutting elements during operation of the rock bit, as well as reducing the formation of cracks in the rock bit during operation of the rock bit.

In one type of roller cone bit embodiment, the method may comprise providing a rock bit with roller cones, and cutting elements having cylindrical bodies with a diameter; forming pockets in the roller cones to a first axial depth with a first bottom (e.g., about half way), the pockets having a cylindrical shape with a first diameter that is smaller than the diameter of the cutting elements, the pockets also having corners at surfaces of the roller cones; carburizing interior portions of the pockets at the first depth (i.e., on the initially formed temporary “bottom” and the side wall portions surround the first bottom, but not the corners of the pocket) to form “circumferential waistbands” of carburization about interior walls of the pockets at the first depth; cooling the roller cones; deepening the pockets to a second depth having a second (and final) bottom, such that the circumferential waistbands of carburization remain in the pockets and any carburization on the first bottom is removed.

Yield strength for a carburized, quenched and tempered surface will be a function of the carbon content. Also, notch sensitivity will rise with reduced carbon content. Thus, if a portion of the carbon gradient is removed, the sensitivity of the pocket material to cracking during the insertion of the compact will be reduced. The yield strength and toughness can be tailored by removing a portion of the carburized case.

In a next step, the roller cones are heated (e.g., austentizing, oil quenching and tempering the roller cones). In a shrink fitting embodiment, the roller cones are heated to expand the pockets to a second diameter that is approximately equal to the diameter of the cutting elements. The heating step increases a yield strength of the pockets and increases retention of the cutting elements in the pockets.

The method also comprises cooling and cleaning the cutting elements and the pockets of the roller cones; placing a material (e.g., fluid or disks) on the second bottoms in the pockets; and then installing (e.g., pressing) the cutting elements in the pockets to form roller cone assemblies such that the material is located between the second bottoms and bottoms of the cutting elements. The roller cones are not necessarily heat treated, and the pockets may be milled into the roller cones. The method also may further comprise machining the circumferential waistbands of carburization to a selected thickness.

While the invention has been shown or described in only some of its forms, it should be apparent to those skilled in the art that it is not so limited, but is susceptible to various changes without departing from the scope of the invention.

What is claimed is:

1. A method of forming a rock bit, comprising:
(a) providing a rock bit with roller cones, and cutting elements having cylindrical bodies with a diameter;
(b) forming pockets in the roller cones to a first axial depth with a first bottom, the pockets having a cylindrical shape with a first diameter that is smaller than the diameter of the cutting elements, the pockets also having corners at surfaces of the roller cones;
(c) carburizing interior portions of the pockets at the first depth to form circumferential waistbands of carburization about interior walls of the pockets at the first depth;
(d) deepening the pockets to a second depth having a second bottom, such that the circumferential waistbands of carburization remain in the pockets and any carburization on the first bottom is removed;
(e) heating the roller cones;
(f) cooling and cleaning the cutting elements and the pockets of the roller cones;
(g) placing a material on the second bottoms in the pockets; and then
(h) installing the cutting elements in the pockets to form roller cone assemblies such that the material is located between the second bottoms and bottoms of the cutting elements.

2. A method according to claim 1 wherein, in step (b), the roller cones have not been heat treated, and step (b) comprises milling the pockets in the roller cones.

3. A method according to claim 1 wherein step (e) comprises austentizing, oil quenching and tempering the roller cones.

4. A method according to claim 1 wherein, after step (d), further comprising machining the circumferential waistbands of carburization to a selected thickness.

5. A method according to claim 1 wherein step (e) increases a yield strength of the pockets and increases retention of the cutting elements in the pockets.

6. A method according to claim 1 wherein the material comprises an incompressible fluid selected from the group consisting of a lubricant, oil, and grease, and the fluid acts as a homogenizing support for the cutting elements during operation of the rock bit.

7. A method according to claim 1 wherein the material comprises plastic or deformable metallic disks.

8. A method according to claim 1 wherein the material reduces the formation of cracks in the roller cones during operation of the rock bit.

9. A method according to claim 1 wherein step (e) comprises heating the roller cones to expand the pockets to a second diameter that is approximately equal to the diameter of the cutting elements in a shrink fitting operation.

10. A method according to claim 1, wherein step (b) comprises forming the pockets and the first bottom is about half way to the second depth, the first diameter that is about 0.060″ smaller than the diameter of the cutting elements, step (c) comprises carburizing the first bottom, but not corners of the pockets, and then cooling the roller cones, and step (h) comprises pressing the cutting elements in the pockets.

11. A method of forming a rock bit, comprising:
(a) providing a rock bit with cutting elements,
(b) forming pockets in the rock bit for the cutting elements, the pockets having a first diameter that is smaller than a diameter of the cutting elements;
(c) carburizing and heating the pockets such that the pockets expand to a second diameter that is approximately equal to the diameter of the cutting elements;
(d) placing a material in bottoms of the pockets; and then
(e) installing the cutting elements in the pockets.

12. A method according to claim 11, wherein step (b) comprises milling the pockets in the rock bit.

13. A method according to claim 11, wherein step (c) comprises oil quenching and tempering the pockets.

14. A method according to claim 11, wherein step (c) increases a yield strength of the pockets and increases retention of the cutting elements in the pockets.

15. A method according to claim 11, wherein the material comprises a fluid, or plastic or deformable metallic disks.

16. A method according to claim 15, wherein the fluid is an incompressible fluid selected from the group consisting of a lubricant, oil, and grease, and the fluid acts as a homogenizing support for the cutting elements during operation of the rock bit.

17. A method according to claim 15, wherein the fluid reduces the formation of cracks in the rock bit during operation of the rock bit.

18. A method according to claim 11, wherein the rock bit is one of a roller cone drill bit and a fixed blade drill bit.

19. A method according to claim 11, wherein step (a) comprises providing the rock bit with cylindrical bodied cutting elements, step (b) comprises forming cylindrical pockets in the rock bit for the cutting elements, the first diameter is about 0.060″ smaller than the diameter of the cutting elements, and the cutting elements are pressed into the pockets.
